(19) United States
(12) Patent Application Publication
(10) Pub. No.: US 2010/0128570 A1
(43) Pub. Date: May 27, 2010

(54) WRISTWATCH INTERFACE SYSTEM

(76) Inventors: Christopher E. Smith, East Cleveland, OH (US); Samuel K. Giles, Holland, OH (US)

Correspondence Address: MICHAEL RIES, 318 PARKER PLACE, OSWEGO, IL, 60543, US

(21) Appl. No.: 12/276,417

(22) Filed: Nov. 24, 2008

(51) Int. Cl. G04B 47/00

(52) U.S. Cl. 368/10

(57) ABSTRACT

The present invention is a more user-friendly wristwatch remote that is programmable to different security systems. The present invention has a wristwatch remote that incorporates a user-friendly means for operating a vehicle security system, manipulating the wristwatch functions, checking the status of the vehicle and/or the security system and lastly, syncing and communicating with other corresponding devices.

### TECHNICAL FIELD & BACKGROUND

The present invention generally relates to the field of wristwatch remotes, more specifically a kind of wristwatch remotes that can be programmable to to different security systems.

We have created a more user-friendly wristwatch remote that is programmable to different security systems. Our wristwatch remote incorporates a user-friendly means for operating a vehicle security system, manipulating the wristwatch functions, checking the status of the vehicle and/or the security system and lastly, syncing and communicating with other corresponding devices. We accomplish this by (1) adding a programmed menu/operating system, (2) omitting the traditional mode button and replacing it with a menu button, (3) adding a scroll-dial/enter tool and (4) incorporating wireless short-range device pairing. The result, compared to existing methods, is a more effective and user-friendly means of: navigating through and manipulating the wristwatch functions, checking the status of the vehicle and security system, sending and receiving information via short-range device pairing.

The problems with digital wristwatch remotes produced in the past are that they:
have consistently comprised of a mode button as the means of accessing and manipulating the various functions of the wristwatch which has not been the most user-friendly means for accomplishing this task. For example, they have been comprised of an unfriendly process of adjusting the time/date and alarm by initially having to hold the mode button for 2-3 seconds and then using a combination of buttons to make these adjustments.
have never been able to connect to multiple devices through short-range device pairing.
have never comprised of an easier means for navigating through the different functions of the wristwatch.
have never been programmable to multiple security systems.
have never comprised of a large capacity of memory.

Our wristwatch remote is preferable over previous digital wristwatch remotes because it comprises of: (a) a programmed menu comprising of watch related and non-watch related options thus allowing access to these options for any reason by the user to be seamless, (b) a scroll-dial/enter tool for easier means of navigating through the programmed menu by using the scrolling action of the tool, selecting options, making and setting adjustments by using the tool as a button, (c) a means for sending and receiving information via short-range device pairing, (d) a menu/home button to take the place of a mode button as means for easier access to watch related and non-watch related options as well as means for returning user from menu options to regular time display, (e) a back button as means for navigating back one menu screen, (f) a means for programming the wristwatch to different security systems and lastly (g) a larger capacity of memory.

In summary, the purposes of our wristwatch remote are to:
1. Provide a wristwatch keyless entry remote that can be programmed for any security system.
2. Provide a wristwatch keyless entry remote that comprises of a programmed menu for easier means of selecting and adjusting watch functions (i.e. time, date etc.) as well as actuating and monitoring the vehicle security system.
3. Provide a wristwatch keyless entry remote that comprises of an easier means for accessing watch related and non-watch related options.
4. Provide a wristwatch keyless entry remote that comprises of a means for returning user from menu options to regular time display.
5. Provide a wristwatch keyless entry remote that comprises of a means for sending and receiving information via short-range device pairing.
6. Provide a wristwatch keyless entry remote that comprises of a means for navigating back one menu screen.
7. Provide a wristwatch keyless entry remote that comprises of a larger capacity of memory.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a frontal view of wristwatch interface, in accordance with one embodiment of the present invention;

FIG. 2 is a right side view of wristwatch interface, as viewed from right-hand side of FIG. 1, in accordance with one embodiment of the present invention;

FIG. 3 is the left-hand side view of wristwatch interface, as viewed from left-hand side of FIG. 1, in accordance with one embodiment of the present invention;

FIG. 4 is a bottom view of the wristwatch interface, in accordance with one embodiment of the present invention;

FIG. 5 is a block diagram showing the component parts of the wristwatch interface, in accordance with one embodiment of the present invention;

The components of our invention and how they interact:

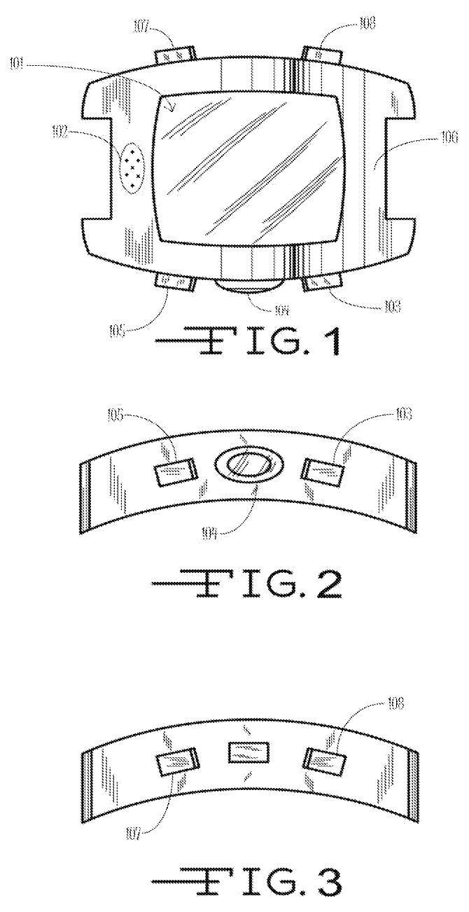

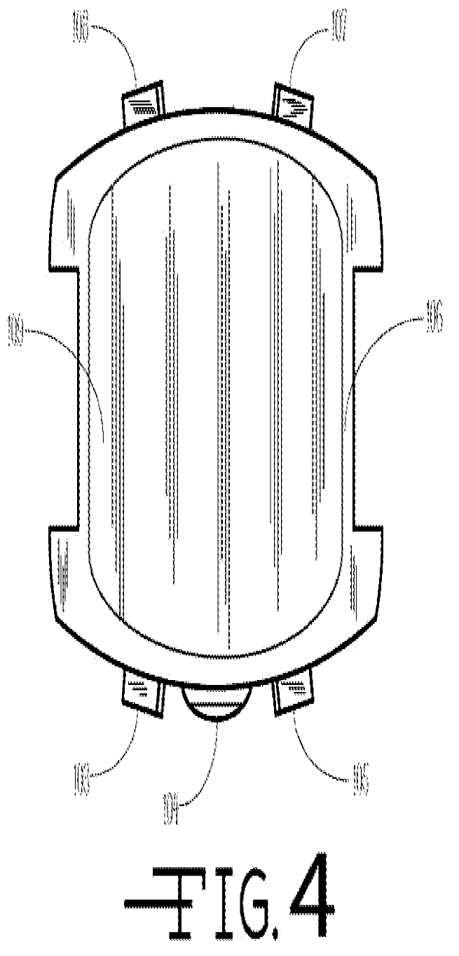

### FIGS. 1-4

101 Display Section
102 Speaker/Microphone
103 Menu/Home Button
104 Scroll-Dial/Enter Tool
105 Back Button
106 Watch casing
107 Automatic Start
108 Arm & Lock/Disarm & Unlock

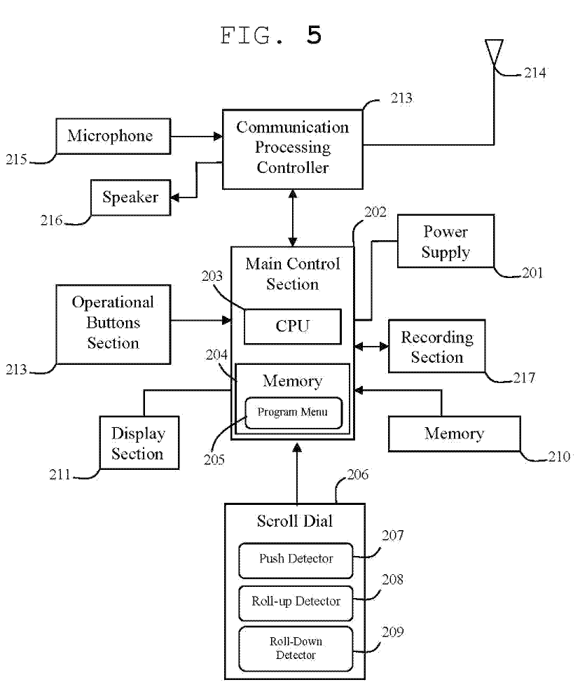

### FIG. 5

201 Rechargeable Power Supply
202 Main Control Section
203 CPU
204 Memory
205 Program
206 Jog-Dial
207 Push Detector
208 Roll-up Detector
209 Roll-Down Detector
210 Memory
211 Display Section
212 Operational Button Section
213 Communication Processing Controller
214 Antenna
215 Microphone
216 Speaker
217 Recording Section

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

Referring to the diagrams of FIG. 1 through FIG. 4, The wristwatch interface 1 is covered with a casing 106 having a front surface provided with a display section 101 for displaying various types of information to a user during device pairing, a telephone conversation, transmission and reception of vehicle security system commands, transmission and reception of E-mails and text messages, transmission and reception of various information services and the like (all of which are generically referred to hereinafter as “information communication”).

Also, the wristwatch interface comprises of a group of operational buttons for accepting various manual inputs. A menu button 103 in place of a mode button making it easier to access watch related and non-watch related options and a back button 105 as means for navigating back one menu screen. The group of operational buttons also comprises of vehicle security system operational short-cut buttons that bypass the need to scroll through the operational menu. A remote start operational button 107 provides a user an immediate option to activate a vehicle ignition while an arm & lock/disarm & unlock button 108 activates and deactivates the vehicle security system. Also, any of the operational buttons (103, 104, 105, 107 & 108) provide, when depressed, backlight illumination on the display screen for easy reading in the dark.

A scroll-dial/enter tool 104 for easier means of navigating through the programmed menu by using the scrolling action of the tool, selecting options, making and setting adjustments by using the tool as a button. A microphone 102 for use during a telephone conversation, voice data recording and vehicle security system or cellular phone voice commands. The provision of the display and the group of operational buttons on the same surface of the watch casing 106 or on surfaces thereof facing in substantially the same direction allows the user to operate the wristwatch interface 1 while viewing a display section 101 of the display.

FIG. 5 is a block diagram showing components of the wristwatch interface 1, particularly about a main control section 202 therein. As shown in FIG. 5, the main control section 202 is electrically connected to the various components of the wristwatch interface 1 to control the entire operation of the wristwatch interface 1. The main control section 202 includes a CPU 203 for performing various computations, and a memory 204 for storing an operating program menu 205 therein. The CPU 203 performs the computations in accordance with the program menu 205 to effect the navigation through manipulation of operational menus of the wristwatch interface 1. The operational button section 212 provides a user with a short-cut to specific wristwatch interface functions. During an incoming information communication call, the wristwatch interface program 205 will switch the functionality of the operational buttons section 212. For example, when an incoming information communication call is present, the wristwatch interface will allow a user to ignore the incoming call or accept the incoming call by depressing one of the operational buttons or scrolling and selecting “Accept” or “Ignore.” The CPU 203 interprets user input from the operational button section 212 and scroll-dial 206 then processes the input information to be viewed in the display section 211. As a means for short range device paring, the wristwatch interface 1 will also comprise of a rechargeable power source 201, an antenna 214 and communication processing controller (CPC) 213.

Communication processing controller 213 is a section for communicating with the exterior through the antenna. In the wristwatch interface 1, the CPC 213 communicates with an antenna of other devices using radio waves. When the wristwatch interface 1 is out of range with a vehicle security system and a user actuates a vehicle security system function, the CPC 213 and main control section 202 recognizes the loss of network between the wristwatch interface and the vehicle security system. Then, the main control section 202 proceeds to utilize the paired network between the wristwatch interface 1 and a user's cellular phone to send an operational signal through the CPC 213 to the paired cellular device. The paired cellular device then sends the operational signal through its wireless cellular infrastructure to the vehicle security system.

The scroll-dial 206 has a disk-shaped rotary member (designated by the reference numeral 104 in FIG. 1). The scroll-dial 206 further comprises a push detector 207 for detecting a push of the rotary member, a roll-up detector 208 for detecting counterclockwise rotation of the rotary member, and a roll-down detector 209 for detecting clockwise rotation of the rotary member. Such an arrangement achieves various operations efficiently. The push detector 207 may be capable of detecting a half-pressed position and a full-pressed position. The wristwatch interface 1 may be adapted so that the user's operations using the scroll-dial 206 can be performed also using the operational buttons 212.

During information communication such as short range device pairing, the scroll-dial 206 is used to select operational menu items and the selection items are displayed on the display section 211. More specifically, when the user rotates the rotary member, a tentatively selected item is changed in order between a plurality of items displayed on the display, based on signals from the roll-up detector 208 and the roll-down detector 209. Then, when the user pushes the rotary member inwardly of the wristwatch casing (designated by the reference numeral 106 in FIG. 1), the selection of the tentatively selected item is determined, based on a signal from the push detector 207.

The microphone 215 not only is used during a telephone conversation while the wristwatch interface 1 is being paired with a cellular phone but also functions to record voice information. For voice recording on memory 210, a recording process is performed by utilizing the scroll-dial to scroll through menu options and selecting the voice record menu option by pushing the rotary member in. For playback of a voice recorded data, data to be played back is selected by rotating the rotary member, and the voice recorded data is played back using the rotary member and selecting a predetermined menu option to initiate playback. Also, the microphone 215 will be used for voice command reception. A user will program set audible commands to act as functional short-cuts for certain wristwatch interface applications, such as to remotely start an automobile or ignoring incoming calls. Such audio command will be received by the microphone 215, processed by the CPC 203 and computed in accordance to the operation program 205.

The wristwatch interface 1 is usable as a speaker phone which allows the user to have a telephone conversation while pairing with other devices. In this case, information communication about vehicle security system functions and pairing with a cellular phone for a telephone conversation is carried out while the CPC 213 performs continuous device paring between a vehicle security system and a cellular phone. In such an operation, the speaker 216 receives incoming communication information by way of the antenna 214 and CPC 216. Also, vehicle security system functions are changed by rotating the rotary member of the scroll-dial 206 or depressing an operational button 212 and an operational signal is sent to a paired device. Another function of the speaker 216 is to provide the user with audible confirmation of selected menu items. When a user depresses an operational button 212, selects a menu item with the scroll-dial 206, or utilizes voice commands, the main controller section 202 sends a confirmation audio signal to the CPC 213 and then is executed by the speaker 216.

A recording section 217 is a temporary memory for recording voice data obtained by the microphone 215. The recorded voice data is transferred from the recording section 217 through a main control section 202 to memory 210, as needed, in accordance with a user's instruction. Additionally, the recording section 217 can receive the voice data recorded on the memory 210 through the main controller section 202 so that a playback of the voice data is displayed on the display section 211.

Our invention achieves its result by:
Arm/lock vehicle—the user would only have to depress the arm/lock button and the vehicle will arm/lock.
Disarm/unlock vehicle—the user would only have to depress the disarm/unlock button and the vehicle will disarm/unlock.
Remote Start—the user would only have to depress the remote start button and the vehicle will remotely start its engine.
Menu—to access the main menu screen the user would only have to depress the menu button and the screen will display a list of options as follows:
   1. Watch
   2. Vehicle
   3. Phone
   4. Settings
   5. Applications
Adjust time/date/alarm—to adjust the time the user would have to depress the menu button, after which the main menu screen would be displayed showing the list of menu options. The user would scroll to the “watch” option using the scrolling action of the scroll-dial/enter tool and select the “watch” option using the scroll-dial/enter tool as a button by depressing the tool. The screen would then display another list of options that are as follows:
   1. →set time
   2. →set date
   3. →set alarm
The user would then scroll to and select the “set time”, “set date” or “set alarm” option using the scroll-dial/enter tool. At this point the user can adjust the hour, minutes and/or month and day using the scrolling action of the scroll-dial/enter tool and set each hour and minute and/or setting each month and day by using the scroll-dial enter tool as a button by depressing the scroll-dial/enter tool.
Access Vehicle Options—to access and operate several of the vehicle options the user would have to depress the menu button, after which the main menu screen would be displayed showing the list of menu options. The user would scroll to the “vehicle” option using the scrolling action of the scroll-dial/enter tool and select the option using the scroll-dial/enter tool as a button by depressing the scroll-dial/enter tool. The screen would then display another list of options that the user can select to manipulate the vehicle through the security system as well as check the status of the vehicle and security system. That list of options are as follows:

1. →Panic
2. →Trunk Release
3. →Vehicle Status (select)→armed/locked, disarmed/unlocked

→interior lights on/off
→windows open/closed

4. →Windows (select)→front windows (select)→open (by %'s or
entirely)

→close (by %'s or
entirely)

→rear windows (select)→open (by %'s or

entirely)

```
  →close (by %'s or
  entirely)
```

The user would then scroll to and select the “panic”, “trunk release”, “vehicle status” or “windows” option using the scroll-dial/enter tool. At this point the user can actuate the windows to open/close by percentages, the alarm to sound or the trunk to open. The user will also be able to scroll to and select the “vehicle status” option allowing the user to receive vehicle status information about the vehicle currently being armed/locked, disarmed/unlock, and/or if interior lights are on/off and if windows are open/closed all of which would be done through two-way communicating between the security systems vehicle brain-box and the wristwatch remote.
Access Phone Options—to access and operate several of the phone options the user would have to depress the menu button, after which the main menu screen would be displayed showing the list of menu options. The user would scroll to the “phone” option using the scrolling action of the scroll-dial/enter tool and select the option using the scroll-dial/enter tool as a button by depressing the scroll-dial/enter tool. The screen would then display another list of options the user can select to view cellular phone information via short-range device pairing. The options and information that could be viewed are as follows:

1. →address book
2. →calendar/datebook
3. →calls (select)→received

→dialed

4. →messages (select)→inbox (#)

→outbox (#)
→v-mail (#)

→text (#)

→e-mail (#)

The user would then scroll to and select the “address book”, “calendar/datebook”, “calls” (received/dialed)/” or “messages” (inbox/outbox/v-mail/text/e-mail) option using the scroll-dial/enter tool. At this point the user can access a paired devices address book, calendar/datebook, and/or view the calls the user has received/dialed as well as the total number of messages in the inbox/outbox (text) and v-mail (voice-mail) by scrolling to and selecting the option of choice and, if applicable, one of its sub options. All access to paired devices would be accomplished through short-range device pairing.
Access Settings—to access the settings of the wristwatch the user would have to depress the menu button, after which the main menu screen would be displayed showing the list of menu options. The user would scroll to and select the “settings” option using the scroll-dial/enter tool. The screen would then display another list of settings that the user can select and make adjustments to. The settings that would be viewed are as follows:

1. →text messages (select)→on

→off

2. →caller id (select)→on

→off

3. →connection (select)→bluetooth (select)→on

→off

→locate bluetooth devices

→sync

4. →audio (select)→style (select)→loud

→soft
→vibrate
→vibe & beep
→silent

5. →personalize (select)→watch faces (select)→face 1

→face 2
→face 3 etc.

→backlight color (select)→red

→green
→blue etc.

6. →voice commands (select)→

→
→
→

The user would then scroll to and select the “text messages”, “caller-id”, “connection”, “audio”, “personalize” or “voice commands” option using the scroll-dial/enter tool. At this point the user can select the “text messages”, “caller-id” option and turn these functions on/off. The user could also scroll to and select the “connection” option and turn the wristwatches means for short-range device pairing on/off as well as locate devices for short-range pairing. The user could also scroll to and select the “audio” option and change the alert styles to loud, soft, vibrate, vide and beep or silent. The user could also scroll to and select the “personalize” option and change the digital face of the watch and the backlight color. Lastly, the user could scroll to and select the “voice commands” option and assign voice commands to different functions.
Access Applications—to access the applications of the wristwatch the user would have to depress the menu button, after which the main menu screen would be displayed showing the list of menu options. The user would scroll to and select the “applications” option using the scroll-dial/enter tool. The screen would then display another list of settings that the user can select and use. The applications that would be viewed are as follows:
   1. →voice recorder
   2. →stop watch
   3. →MP3 Player
The user would then scroll to and select the “voice recorder”, “MP3 player” or “stop watch” option using the scroll-dial/enter tool. At this point the user can select the “voice recorder” option and record a personal voice message. The user could also scroll to and select the “stop watch” option and start/stop it. The user could also scroll to and select the “MP3 player” option and play music that has been downloaded and/or sent wirelessly to the wristwatch.

Entire Menu Program
Main Menu Options

| | |
|---|---|
| I. | Watch |
| II. | Vehicle |
| III. | Phone |
| IV. | Settings |
| V. | Applications |

Options under selected main menu options

I. Watch Options(select)

1. →set time
2. →set date
3. →set alarm

II. Vehicle Options(select)

1. →Panic
2. →Trunk Release
3. →Vehicle Status (select)→armed/locked, disarmed/unlocked

→interior lights on/off
→windows open/closed

4. →Windows (select)→front windows (select)→open (by %'s or

entirely)

→close (by %'s or

entirely)

→rear windows (select)→open (by %'s or

entirely)

→close (by %'s or

entirely)

III. Phone Options(select)

1. →address book
2. →calendar/datebook
3. →calls (select)→received

→dialed

4. →messages (select)→inbox

→outbox
→v-mail
→e-mail

IV. Settings(select)

1. →text messages (select)→on

→off

2. →caller id (select)→on

→off

3. →connection (select)→bluetooth (select)→on

→off

→locate bluetooth devices
→sync

4. →audio (select)→style (select)→loud

→soft
→vibrate
→vibe & beep
→silent

5. →personalize (select) →watch faces (select)→face 1

→face 2
→face 3 etc.

→backlight color (select)→red

→green
→blue etc.

6. →voice commands (select)→Remote Start

→Arm/Lock
→Disarm/Unlock
→Trunk Release
→Watch
→Vehicle
→Phone
→Settings
→Applications

V. Applications(select)

1. →voice recorder
2. →MP3 Player
3. →stop watch

### Alternative Embodiments

The Inventors have alternative methods of embodying their invention and the inventions components as described below:
the wrist bands can be any material and any color
The entire watch interface can be made in any material and any color.
The display screen can light in various colors.
The backlight can be in any color.
The watch interface can be made any shape and size (ex. Round, rectangular, square etc.)
The outer buttons on the sides of the watch transmitter can be in different shapes, sizes, colors and made from any material.
The watch interface can initiate calls
when a user is out of range of the vehicle security system and a security system command is actuated, the wristwatch interface will command the user's cellular phone to send an operational signal, through the wireless cellular infrastructure, to the vehicle security system.
The watch transmitter can have automatic sliding components.
The display screen can be in various sizes and shapes.
Some of the programmed menu options can be omitted.
Some of the buttons can be omitted.
The buttons can be arranged in any way.
The menu options can be arranged in any way.
Additional menu options can be added.
The digital watch remote will be able to operate other power functions for different vehicles (ex. Power rear gate and power side sliding doors for mini-vans).
The battery can be a rechargeable.
The rechargeable power source can be solar.
Provides means to transmit paging signal to an audible receiver
Can provide voice recognition functionality.
The home and back buttons can be omitted if programmed menu comprises these features.
The programmed menu can comprise of a home option and a back option in lieu of buttons.
The programmed menu can comprise of a stop watch feature.
The programmed menu can comprise of a sunroof feature for opening and closing the sunroof by percentages.
The programmed menu can comprise of a diagnostic feature for viewing information related to the vehicles performance.
The programmed menu can comprise of a loud detail feature for adjusting the volume of the alert.
The programmed menu can comprise of an internal storage for phone numbers.
The programmed menu can comprise of an internal storage for calendar items.
The programmed menu can comprise of a digital calculator.
The programmed menu can comprise of a key finder.

While the present invention has been related in terms of the foregoing embodiments, those skilled in the art will recognize that the invention is not limited to the embodiments depicted. The present invention can be practiced with modification and alteration within the spirit and scope of the appended claims. Thus, the description is to be regarded as illustrative instead of restrictive on the present invention.

What is claimed is:

1. A wristwatch remote comprising:
a user-friendly means for operating a vehicle security system, manipulating wristwatch functions, checking a status of a selected one of a vehicle and the security system and syncing and communicating with other corresponding devices; and
a programmed menu/operating system, a menu button, a selected one of a scroll-dial and enter tool and a wireless short-range device pairing.

2. A wristwatch remote comprising:
a programmed menu having watch related and non-watch related options thus allowing access to these options for any reason by the user to be seamless;
a selected one of a scroll-dial and enter tool for easier means of navigating through the programmed menu by using the scrolling action of the tool, selecting options, making and setting adjustments by using the tool as a button;
a means for sending and receiving information via short-range device pairing;
a selected one of a menu and home button to take the place of a mode button as means for easier access to watch related and non-watch related options as well as means for returning user from menu options to regular time display;
a back button as means for navigating back one menu screen;
a means for programming the wristwatch to different security systems; and
a memory of a large size.
